(19) United States
(12) Patent Application Publication
(10) Pub. No.: US 2015/0342387 A1
(43) Pub. Date: Dec. 3, 2015

(54) Apparatus for Modified Heated Air Flow to Food Holder

(71) Applicant: Alfred R. Wagner, Post Falls, ID (US)

(72) Inventor: Alfred R. Wagner, Post Falls, ID (US)

(21) Appl. No.: 14/823,984

(22) Filed: Aug. 11, 2015

Related U.S. Application Data
(63) Continuation-in-part of application No. 12/932,214, filed on Feb. 22, 2011.

(51) Int. Cl. A47J 27/026; A47J 36/26

(52) U.S. Cl. CPC A47J 27/026; A47J 36/26

(57) ABSTRACT

A food warming and cooking apparatus used over a burner of a range or similar heat source. The apparatus has a base section adapted to cover the heater and help contain heated air therein. A base unit having a plurality of spacedly arrayed louvers emit heated air into an intermediate assembly. A food holder is placed into the intermediate assembly during operation. One or more guides position the food holder for even cooking. Hot air is emitted in a manner that induces lateral and vertical motion to the air providing greater heat transfer at relatively lower temperatures than would be experienced by direct contact of a food holder or other cooking implement to reduce the risk of sticking and scorching.

### RELATED APPLICATIONS

This utility patent application is a Continuation in Part (CIP) of Prior Filed currently pending U.S. application Ser. No. 12/932,214 titled APPARATUS FOR MODIFIED HEATED AIR FLOW TO FOOD HOLDER filed on Mar. 22, 2011 by the same inventor, Alfred R. Wagner, a citizen of the United States and a resident of Kootenai County in the State of Idaho. The entire contents of the aforementioned prior filed U.S. application Ser. No. 12/932,214 are expressly incorporated herein by this reference.

### BACKGROUND AND DESCRIPTION OF THE PRIOR ART

Heating and warming devices are well-known in the art of foodstuffs. Some foodstuffs are particularly difficult to heat without the cook watching and stirring to maintain the contents at even temperatures to avoid sticking, scorching, boiling over, and similar problems or inconveniences. This is particularly illustrated with fluidic and semi-fluidic food stuffs such as, but not limited to, sauces, gravies and melted solids such as chocolate, caramel and the like. It is also desirable to heat such contents without making a mess upon adjacent countertops and floors by avoiding bubbling and spattering.

Many prior devices suffer from the inability to eliminate overheating. Another problem suffered by most devices for heating contents susceptible to sticking are hot spots on the bottom of the pots or other containers or at other locations thereon. Overheating and uneven heating may cause foodstuffs being heated to stick, scorch or burn on the inside of the pot or container and transfer a “taste” or “odor” of char or burning to the entire food stuff. Overheating and uneven heating may be further exacerbated by the “beginning” temperature of the food stuff prior to cooking. For example, fully thawed and room temperature food stuffs tend to cook and/or melt quickly and consistently. On the other hand, frozen food stuffs or food stuffs that are not completely thawed may burn or “dry out” on exterior portions while interior portions may remain frozen or uncooked. Food stuffs having low “beginning” temperatures, such as items removed directly from a refrigerator or cooler (typically approximately 33-40 degrees F) will behave similarly to frozen food stuffs but less dramatically and may require even more continuous observation and attention from a cook. Even further still, the “beginning” temperature has a direct and significant impact on the overall cook time of the food stuff, as well as the resulting taste and moisture content throughout.

Until now, efforts to avoid the above-mentioned problems and control heat have involved what are commonly called “slow cookers” also commonly known as “Crock Pots®”. These slow cookers keep the temperature inside a cooking vessel relatively low and even. In many cases heavy ceramic cooking vessels have been used to keep temperatures on the inside surface even and at the desired relatively low temperature levels. In known slow cookers, heat is generated in an outer/surrounding container that is typically electrically powered. The heat generated by the outer/surrounding container is passed by direct conduction to an inner “crock” that contains/carries the food stuff. The heat conduction is direct surface-to-surface conduction because the inner foodstuff containing container directly frictionally rests upon or is carried within the heated surrounding container. Heat flux is consistently low, distributing heat to the foodstuff container and to the contents thereof in a manner which requires long periods of time, generally at least several hours and more commonly during the course of a working day.

The prior art also includes relatively complex heating devices, many having various controls for temperature, time or other operational parameters. These devices, in addition to the prior mentioned failings, (e.g. scorching, spattering and lengthy cook times) often suffer from their complexity. Such features have caused users to misuse the devices or suffer difficulties. Such misuse and difficulties may be due to impatience causing overheating, prematurely turning the device off, and forgetting to turn the device on or off. Inconsistent results thus commonly occur due to the uneven heating and operational misuse caused by prior heating apparatuses for foodstuffs and the like which cannot be heated under high heat flux.

Thus, there has been a long-felt need for a cooking apparatus which can heat foodstuffs in a manner which avoids or minimizes sticking, scorching and burning, does not require frequent stirring or active monitoring and is less likely to soil surfaces with spattering contents and does not require multiple hours of time to heat/cook the foodstuff. My invention is portable and provides foodstuffs that are cooked with the quality and moisture normally reserved for foodstuffs prepared in slow cookers. My invention is usable with standard sized cooking pots which furthers its versatility. Further still, my invention provides slow cooked quality foodstuffs without the time required for using a slow cooker.

It is believed that to date all prior devices suffer significantly from one or more of these or other problems. The current inventions seek to successfully address this long-felt need by minimizing or eliminating such problems, constraints and difficulties. More specifically the instant inventions provide heat for cooking foodstuffs using heated air with no direct surface to surface conduction, and the instant inventions cooks quickly rather than taking hours and hours.

### BRIEF DESCRIPTIONS OF THE DRAWINGS

Preferred forms, configurations, embodiments and/or diagrams relating to and helping to describe preferred aspects and versions of the inventions are explained and characterized herein, often with reference to the accompanying drawings. The drawings and all features shown therein also serve as part of the disclosure of the inventions of the current document, whether described in text or merely by graphical disclosure alone. Such drawings are briefly described below.

FIG. 1 is an exploded perspective view of a preferred apparatus according to the inventions.

FIG. 2 is a top view of an intermediate assembly 200.

FIG. 3 is a side view of the intermediate assembly 200.

FIG. 4 is a bottom view of the intermediate assembly 200.

FIG. 5 is a top view of the base unit 100.

FIG. 6 is a side view of the base unit 100.

FIG. 7 is a top view of a preferred positioner 500 used in the intermediate assembly 200.

FIG. 8 is a side view of the positioner 500.

FIG. 9 is a front view of the positioner 500.

### DETAILED DESCRIPTION OF THE INVENTIONS

### Introductory Notes

The readers of this document should understand that the embodiments described herein may rely on terminology used in any section of this document and other terms readily apparent from the drawings and the language common therefor as may be known in a particular art and such as known or indicated or provided by dictionaries. Dictionaries were used in the preparation of this document. Widely known and used in the preparation hereof are Webster's Third New International Dictionary (© 1993), The Oxford English Dictionary (Second Edition, © 1989), The New Century Dictionary (© 2001-2005), and the American Heritage Dictionary of the English Language, (4^{th} Edition, © 2000), all of which are hereby incorporated by reference for interpretation of terms used herein and to more adequately or aptly describe various features, aspects and concepts shown or otherwise described herein using more appropriate words having meanings applicable to such features, aspects and concepts.

This document is premised upon using one or more terms with one embodiment that may also apply to other embodiments for similar structures, functions, features and aspects of the inventions. Wording used in the Claims is also descriptive of the inventions, and the text and meaning of the claims and abstract are hereby incorporated by reference into the description in their entirety as originally filed. Terminology used with one, some or all embodiments may be used for describing and defining the technology and exclusive rights associated herewith.

The readers of this document should further understand that the embodiments described herein may rely on terminology and features used in any section or other embodiments shown in this document and other terms readily apparent from the drawings and language common or proper therefor. This document is premised upon using one or more terms or features shown in one embodiment that may also apply to or be combined with features and aspects of other embodiments to provide additional embodiments of the inventions.

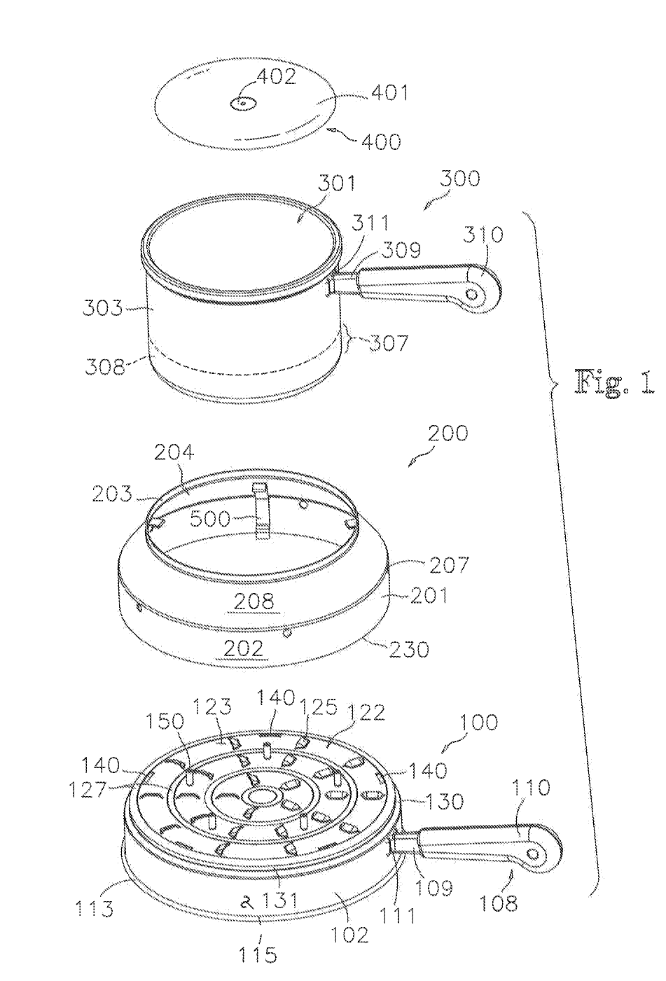

FIG. 1 shows an exploded view of a preferred assembly according to which various inventions hereto have been illustrated for ease of understanding. A brief review of FIG. 1 indicates that there is a base unit 100, intermediate assembly or collar 200 and a food holder 300. The parts assemble with the base unit 100 positioned over a heat source such as an electric or gas range (not shown), the intermediate assembly 200 positioned on the base unit 100, and a food holder 300 positioned above the base unit 100 and with portions of the food holder 300 within the intermediate assembly 200. Food is gently cooked in the food holder 300 using this novel arrangement. A lid 400 may be included to cover the top opening of the pot or food holder 300.

FIGS. 1, 5 and 6 show one preferred construction for base unit 100. The preferred base unit 100 has a sidewall 102. Lower edge of the sidewall 102 preferably has a rim 113 which increases the strength of the side wall 102 and provides greater durability. Within rim 113 is a bottom opening (not shown) which is defined by rim 113 or other suitable structures upon the lower side of the base unit 100.

The preferred construction for base unit 100 also advantageously includes an integrated top wall 122. Side wall 102 and top wall 122 are preferably joined to better serve in performing as heat containment walls to contain or capture heat provided by a heat source (not shown) over which the base unit 100 is placed.

In general, burners and heating units used on typical cooking ranges and other heating appliances have some ventilation which occurs from an area open beneath the burner or heating element. An upper surface of the cooking range (not shown) is generally relatively flat or planar so that rim 113 may frictionally rest upon the generally flat surface formed by range top. The specifics of the range designs vary but air flow is desired to provide air to the area about the heating element or other heat source. The heated air is then partially collected and generally contained within an open bottom interior chamber 115 defined in the base unit 100 by the sidewall 102 and the top wall 122.

Whichever source of heat is used for the burner or other heat source the base unit 100 still performs beneficial effects in helping to contain heated air and provides for heat capacitance in the interior chamber 115. It is preferred that at least some cool air intake or ventilation be provided so that air may flow into and out of the instant invention to provide convective heat to the food holder 300.

The base unit 100 has several functions. In one aspect the base unit 100 functions as a container for collecting and containing heat provided from a suitable heat source, such as an electrical heater, gas range, propane burner or other cooking appliance. Exemplary heat sources include, but are not limited to, a range top heating coil elements (not shown), gas fuel burner (not shown), infrared heating elements, electric hot plates and other suitable heat sources available for cooking. The base unit 100 further acts to gather and contain heat by forming a somewhat close fit with the range top (not shown) which may be a flat area about a heating element, or about a gas burner, both as are frequently used in cooking.

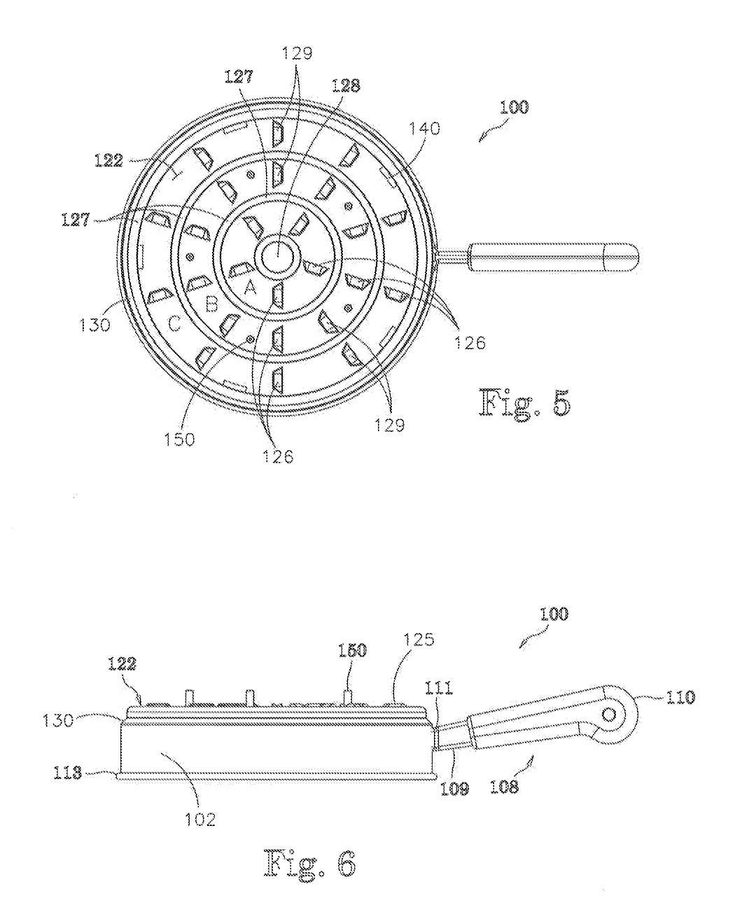

FIGS. 5 and 6 show a preferred embodiment of the base unit 100 having a novel construction. As shown, the base unit 100 is preferably built in a form that includes a side wall 102 to help contain heat therein. This preferred and illustrated construction also may include a top wall 122 which forms another heat containment wall which in this preferred construction is integral with the-side wall 102. The side wall 102 and the top wall 122 define an open bottom interior chamber 115. In another embodiment, it may be suitable to have the side wall 102 and top wall 122 detachable from one another and still have an operable apparatus, but an integrated structure is currently preferred.

The base unit 100 is a heat modifier which operates by converting the relative balance of the different types of heat transfer modes to transfer heat to the food holder 300. For example, a typical food holder 300 receives heat by several different modes. One mode is direct conduction from a heating element to the bottom of the food holder 300. Another typical mode of heat transfer is by convection with hot air around the heating element heating the bottom and sides of the food holder 300.

Another typical heat transfer mode is radiant heat wherein the heat is transferred to the food holder 300 by beaming the radiant heat. This is exemplified by a glowing orange heating element that beams radiant heat not only to food holder 300 which is typically immediately adjacent thereto but also to any surface upon which the radiant heat waves may strike or otherwise impinge. Similarly, a gas flame produces radiant heat as well as conductive and convective heating. The particular heater being used may have different relative balances of different modes of heat transfer, such as the balances of convective, conductive and radiant heat transfer modes.

The instant base unit 100 not only modifies these modes of heating and possibly other modes of heating, but also tends to change the balance of the heating modes between different types of heat sources into a predominantly convective heating mode.

Further, the nature of each or some of these modes of heat transfer may be modified by the instant base unit 100 in the degree and way in which that mode of heat transfer occurs. For example, the base unit 100 as shown changes convective heating by changing the amount of heated air impinging upon the food holder 300 and the direction in which the heated air is directed, the velocity of the heated air and the angle of impingement of the heated air upon the food holder 300.

The base unit 100 is also a heat controller by limiting the amount of radiant heat, conductive heat and convective heating impinging upon the food holder 300. The heat controller function shields the food holder 300 from heat transfer modes including direct radiant heating, direct convective heat exposure, and by preventing direct conductive heating.

The base unit 100 has a handle 108 which includes a shaft 109 and a grip 110. The shaft 109 is connected in various suitable ways, such as by weldment 111, fastening with fasteners or rivets (not shown), or other suitable connection which is advantageously a strong and heat resistant connection. The shaft 109 is as shown welded 111 to the side wall 102 of the base unit 100. Mechanical connections may also be used.

The base unit 100 is also adapted to receive the intermediate assembly 200 using a circumferentially extending ledge 130 which preferably mates with a complementary sized lower edge 230 of the intermediate assembly 200. Other features may also be provided to facilitate assembly and maintain proximity between the base unit 100 and intermediate assembly 200. Exemplary added features are explained in greater detail below.

The top wall 122 has an upper surface 123 which is shown as being generally planar and defining a plurality of spacedly arrayed louvers 125 and plural radially spaced circumferential dividers 127. The circumferential dividers 127 are advantageously arranged between radially spaced rings of louvers 125. The dividers 127 extend in a suitable shape depending upon the shape of the top wall 122 or as is otherwise suitable. As shown, the top wall 122 is generally circular. A radially outermost circumferential divider 127 is proximate the top outer portion of the top wall 122 of the base unit 100. An inner circumferential divider 127 encloses a center section 128 (FIG. 5). As shown in FIG. 5, there are four radially spaced dividers 127 defining the center section 128 and three radial zones A, B, C in which the plurality of spacedly arrayed louvers 125 are arrayed.

The instant invention also advantageously includes at least three standoff pillars 150 which, as shown, are implemented in the form of a plurality of spacedly arrayed standoff pillars 150 (FIGS. 1, 5 and 6). These standoff pillars 150 provide vertical support to the food holder 300, specifically at a bottom 308 of the food holder 300 and serve to determine the lowest position possible. The small surface area of upper end portions of the standoff pillars 150 where such standoff pillars 150 frictionally communicate with a bottom portion of the food holder 300 reduces heat transfer by conduction.

The intermediate assembly 200 has positioners 500 which may be positionally adjusted relative to the intermediate assembly 200 both vertically and laterally depending upon the size of the food holder 300 being used. In preferred use at this time, the food holder 300 rests on the standoff pillars 150 and is laterally positioned or both laterally and vertically positioned by the positioners 500.

As is illustrated and easily seen in FIG. 1, the preferred base unit 100 has a top wall 122. Top wall 122 defines a plurality of spacedly arrayed louvers 125 and other features of significance in modifying and controlling heat transfer to the food holder 300. This also works with the intermediate assembly 200 to perform the desired heat modifying and controlling effects.

The louvers 125 are shown most clearly in FIGS. 1 and 5. Louvers 125 are preferably configured to provide movement of hot air from within the interior chamber 115 of the base unit 100. Heat is provided by a burner or other heating element (not shown) over which the base unit 100 is placed, for example an electric heating element or gas burner of a cooking range. (Not shown).

Within the open bottom interior chamber 115 defined by the base unit 100 hot air is at least partly contained to form a supply of hot air. The side wall 102 and the top wall 122 of the base unit 100 and the intermediate assembly 200 carried by the base unit 100 causes heated air flow about and across the bottom 308 and portions of the sides of the food holder 300. This configuration provides more efficient use of the heat provided by the burner or heat source (not shown) than when a food holder 300 is merely placed directly upon the heat source. This configuration thus conserves heat and energy. It also provides modified and controlled heat transfer as an effect of the laterally and vertically moving hot air emitted from the interior chamber 115 thorough the louvers 125. The increased heat transfer to the food holder 300 is made usable or possible using the invention. For example, a heat source may be set to provide a “medium-high” heat, however the instant invention prevents scorching or burning of the contents of food holder 300 because there is no direct contact with the heat source and the structure of the instant invention prevents excess heat developing upon the bottom 308 and lower side surfaces 307 of the food holder 300 and along inside surfaces of the food holder 300.

FIGS. 1 and 5 show that the preferred louvers 125 are advantageously implemented in a form having an opening that provides heated air movement from the interior chamber 115 in a single direction—e.g. clock-wise or counter clock-wise about the food holder 300. This is configured in the currently preferred construction as louvers 125 which provide both a desired upward and lateral movement of the heated and emitted air from the interior chamber 115. Heat is transferred to the food holder 300 using the intermediate assembly 200 which has a substantially annular configuration defining an open top medial portion which receives a portion of the food holder 300 partially within the intermediate assembly 200.

As shown, the preferred louvers 125 include at least some surface portions which induce a lateral component of velocity and a vertical component of velocity to the heated air emitted from the base unit 100.

In the currently preferred version, louvers 125 are preferably spacedly arrayed in a radial orientation to direct emitted heated air in a direction roughly perpendicular to a radial line passing through the louvers 125. This helps induce a circular heated air flow. A moving air heating chamber is defined above the base unit 100 top wall 122 and within the intermediate assembly 200, and beneath and about the received portion 307 of food holder 300.

The louvers 125 are advantageously laid out in a substantially radial pattern as best shown in FIG. 5. The louvers 125 have two different patterns. The first louver 125 pattern, or primary louvers 126, have louvers 125 arranged along a radial line such that plural louvers 125 are radially aligned and extend from near the center 128 of the top wall 122 to a position proximate to the ledge 130. The second or secondary louver pattern 129 has less louvers 125 and in the design shown has only two louvers 125 per radii versus three louvers 125 per radii for the primary louver rows 126.

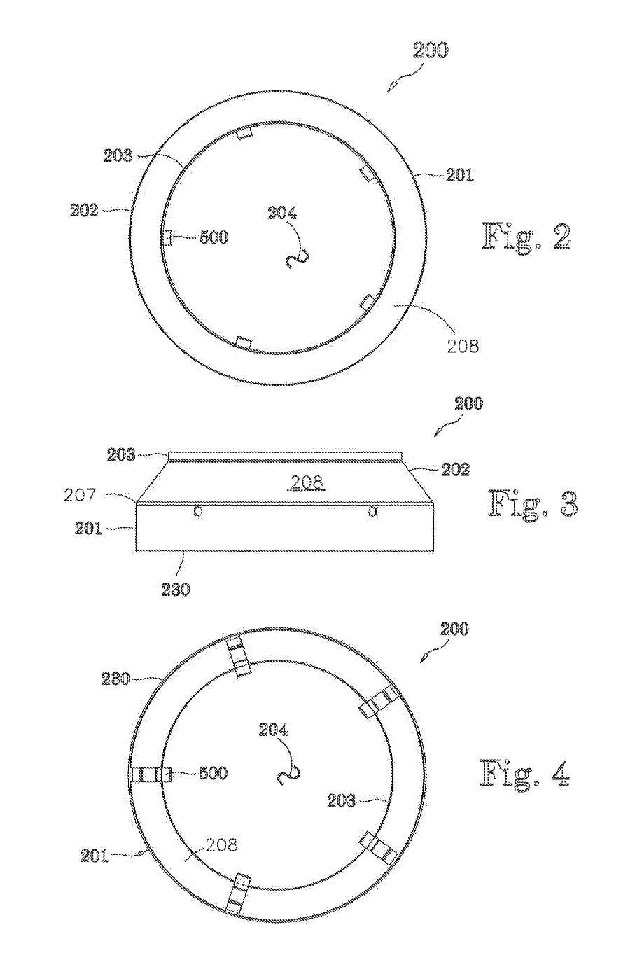

The intermediate assembly 200 (FIGS. 2, 3, 4) may be a simple heat enclosure collar or be formed in other alternative configurations to perform one or more of the functions indicated. As shown, the intermediate assembly 200 is formed as an assembly having a suitably shaped heat enclosure collar and plural positioners 500. The intermediate assembly 200 is beneficial in a number of ways indicated and also is relatively easy to produce.

The intermediate assembly 200, as currently preferred, serves several functions. One function of the intermediate assembly 200 is to help capture heated air emitted through the louvers 125. Also captured is heat that otherwise is transmitted through the top wall 122 by conduction or any incidental radiant heating.

The captured hot air is retained about the bottom 308 and any received portion 307 of the food holder 300. This capture of heat and circulation of heated air provides time for the heat to be transferred to the food holder 300.

Another function of the intermediate assembly 200 is to mate with the base unit 100 in a complementary relationship which aids in retention of a desired amount of heat released from the base unit 100 into the intermediate assembly 200.

Still another function of the intermediate assembly 200 is, to receive at least portions of the food holder 300. The received portion 307 of the food holder 300 is preferably partially within the intermediate assembly 200. The intermediate assembly 200 has a top rim 203 which defines a top opening 204 into which portions of the food holder 300 are received. Depending upon the size of the food holder 300, the manner in which the food holder 300 is positionally maintained within the intermediate assembly 200 may vary. In a preferred embodiment the-food holder 300 has a received portion 307 which fits into the intermediate assembly 200 top opening 204.

The intermediate assembly 200 has a main body which includes the lower section 201 having a sidewall 202 with the lower edge 230, a transition section 208 and a riser or top brim section 203. In addition, there are positioners 500 which are advantageously used for greater facility in positioning the food holder 300. Other suitable shapes may be possible.

The intermediate assembly 200 may also include a transition section 208 suitably joined to the lower section 201. The transition section 208 is shown as a tapered or frusto-conical part. The transition section 208 is joined to lower section 201 at joint 207. A variety of manners of making joint 207 are possible. For example, the joint 207 can be brazed, welded, interference fit, adhered or mechanically rolled to provide suitable joinder. The preferable mode is to stamp the intermediate assembly 200 from a single piece of metal.

The lower edge 230 is beneficially sized to be received upon and engage with the ledge 130 of the base unit 100 to provide a primary positioning engagement between the base unit 100 and intermediate assembly 200. A step (not shown) formed adjacent to the ledge 130, FIG. 6, helps to prevent lateral displacement of the intermediate assembly 200 relative to the base unit 100.

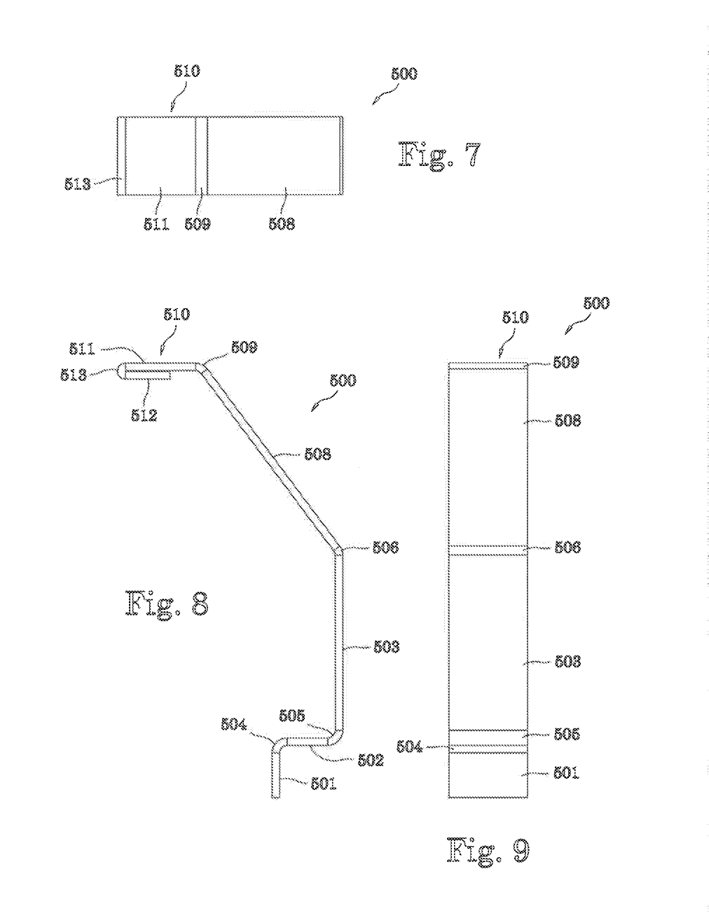

As can be seen in FIG. 1, the base unit 100 top wall 122 may be provided with stabilizer features 140 which enhance the retention of the intermediate assembly 200 upon the base unit 100 in a more secure manner. This secondary engagement is provided in the form of slots or openings 140 which receive or otherwise engage with positioners 500 to help prevent relative movement. As shown, slots 140 receive lower extension sections 501 of the positioners 500 illustrated in FIGS. 7-9.

The transition section 208 represents a change in radial size from a complementary shape relative to the base unit 100 formed by the top wall 122, to a shape suitable for supporting a food holder 300 therein.

As shown, the transition section 208 has an upwardly converging shape, such as the frusto-conical shape shown. The lower transition section 208 slopes inwardly and upwardly to top rim 203. Other configurations are possible.

During operation, the transition section 208 of the intermediate assembly 200 is used to direct the hot air which is moving within the intermediate assembly 200. As shown, the emission of hot air through the louvers 125 causes heated air circulation across the bottom 308 of the food holder 300 and about the received portion 307 in particular. Hot air is also discharged through one or more vents (not shown) created by having the food holder 300 smaller in diameter than a diameter of the top opening 204 defined by top rim 203.

The top opening 204 is preferably larger in diameter than the food holder 300. The top rim 203 preferably extends upwardly in a roughly cylindrical form to provide added strength to resist bending when a food holder 300 falls or impacts to the top rim 203.

Positioners 500 (FIGS. 7, 8, 9) have a unique configuration with a lower extension part 501 for releasable engagement with stabilizer features 140 defined in the base unit 100.

A corner 504 connects to a support section 502 which rests on the top wall 122 of the base unit 100. Corner 505 connects to vertical section 503 which extends along an interior lower section 201 of the intermediate assembly 200. Corner 506 connects to angled upper section 508 which is complementary to the transition section 208 of the intermediate assembly 200.

Corner 509 is between angled upper section 508 and inward distal extension 510. The inward distal extension 510 is provided as shown with a top flange 511, inner bend 513, and a lower flange 512. Inner bend 513 may function as a lateral positioner contact to laterally position the food holder 300 within the intermediate assembly 200.

The positioners 500 are primarily intended to position the food holder 300 in lateral relationship so that an approximately even annular spacing exists about side walls 303 of the food holder 300 and the top rim 203 of the intermediate assembly 200 forming an annular shaped event space. The annular vent space may vary depending upon the construction and materials of the food holder 300 and intermediate assembly 200, the size of each, the heat output of the burner, the heat emitted through the base unit 100 and other factors. It is alternatively possible to have plural vents by segmenting the annular vent space with positioners 500 or other parts to optimize the amount of hot air vented. It is currently believed preferable that a single annular vent be provided so that heating by the venting air is even about the food holder 300.

Food holder 300 defines an interior or contents chamber 301 and has a solid (non-perforated) fluid impermeable bottom (not shown) is for containing food stuffs, preferably fluidic and semi-fluidic foodstuffs to be melted, warmed or cooked at a relatively moderate heat flux. For example, preparation of sauces, melting of chocolate, keeping sauces warm, cooking or warming foods which often done with low heat flux and at low to moderate temperatures can beneficially be performed using the novel constructions according to the inventions hereof. The invention allows a stove burner or other heat source to provide a “medium-high” heat setting and yet be suitable for holding food to be melted, warmed or cooked at a relatively low to moderate heat including but not limited to sauces, soups, chocolate, caramel and other easily overheated materials.

Food holder 300 is advantageously provided in the form of a pot or pan of suitable size. The suitable size of the food holder 300 may be varied. The various sizes are coordinated to the size of the top opening 204 of the intermediate assembly 200 and the positioners 500 (FIG. 2). Placement of the food holder 300 into the intermediate assembly 200 causes a received portion 307 at a lower portion of the food holder 300 sidewall 303 to be received therein.

The food holder 300 may be provided with a convenient handle in preferred versions. FIG. 1 shows a handle 310 with a stem 309 and attachment 311. A heat resistant handle cover 310 is shown.

Food holder 300 is shown with an optional lid 400 in FIG. 1. Conventional, suitably sized lids 400 can be used in the well-known manner. The lid 400 is preferably provided with a knob 402 attached to the lid 400.

When the food holder 300 is positioned with respect to the intermediate assembly 200 top opening 204, then there is preferably a vent opening which extends about the food holder 300 sidewall 303 and within brim 203. In preferred versions the positioners 500 help to keep the spacing uniform about the food holder 300 so that an annular vent opening is created. This helps to direct the hot air venting from within the intermediate assembly 200 interior to vent upwardly along the sides of the food holder 300 providing additional low temperature heat transfer.

In a preferred version the annular space is regularized by the positioners 500 so that heating within the food holder 300 is generally evenly distributed. The spacing typically will vary between one-fourth and three-fourths inches (˜7-21 millimeters) depending upon the size of the food holder 300 and a diameter of the top opening 204, more preferably the space is in the range of approximately one-fourth to one-half inch to retain more heat within the intermediate assembly 200.

Asymmetrical positioning of the food holder 300 within the intermediate assembly 200 may alternatively be possible to have a vent shape which, for example, may reduce heat rising by the handle 310 when properly positioned. Thus a non-uniform spacing may be workable if adequate considerations are made in geometry or other parameters to achieve sufficiently uniform heat flux to the food holder 300.

The invention can be assembled in more than one mode. In a first mode the base unit 100 is joined with the intermediate assembly 200 to provide a cooking apparatus which moderates and changes the heat transmission properties between the food holder 300 and the burner used as the source of heat.

In another assembly the apparatus includes a food holder 300 in combination with the base unit 100 and intermediate assembly 200 when joined. This construction allows the food holder 300 to be used in a conventional way with regard to loading contents thereinto, cleaning and other handling.

Methods performed by the novel constructions shown herein include placing the base unit 100 upon a heat source to provide heated air therein. Methods may further include moderating heat transferred from the base unit 100. The moderating may include emitting heated air through the louvers 125 communicating with the base unit 100 interior chamber 115. The emitting of the collected heat may advantageously be done so as to direct the heated air flow in a desired direction. In one form the emitting of the collected heat is done so as to create circulatory action in the flow of the emitted heated air.

In a further aspect, emitting the heated air through the plurality of louvers 125 produces swirling or heated air and a reduction or elimination of direct incident radiant heat from the heat source (not shown) to the area above the base unit 100 and the food holder 300 being heated.

Methods according to preferred embodiments disclosed herein provide for venting of heated air in such a manner so as to provide relatively even heating across the bottom 308 and about the sides 303 of the food holder 300. This may be accomplished in a variety of ways. One advantageous way is to provide a relatively evenly spaced relationship being the food holder 300 and adjacent parts of the intermediate assembly 200. In some preferred versions the relatively even spacing is facilitated by using positioners 500 which help to position the food holder 300. This may be done to provide lateral positioning of the food holder 300.

Vertical positioning of the food holder 300 relative to the intermediate assembly 200 and base unit 100 is preferably accomplished by spacing the food holder 300 surfaces so as to not be in direct frictional contact with the louvers 125. Even more preferably, spacing is provided between the top wall 122 of the base unit 100 and the food holder 300 bottom by standoff pillars 150 which support the food holder 300 in a suspended condition over the louvers 125 and base unit 100 top wall 122 to reduce direct conductive heat transfer.

Methods according hereto may further be made beneficial so that the heated air within the intermediate assembly 200 moves in a cyclonic or swirling action about the food holder 300. The introducing of heated air into the intermediate assembly 200 having a lateral velocity and a vertical velocity provides continuous movement of heated ambient air about surfaces of the food holder 300. This may further be made beneficial by receiving portions of the food holder 300 with the intermediate assembly 200 and applying heat thereto within the intermediate assembly 200. This applying of heat is advantageously done by moving heated air which may in preferred versions be circulating within the intermediate assembly 200. Such circulating may be rendered further desirable by inducing a swirling action of heated air coming from the base unit 100 and venting the heated air outwardly from the upper opening 204 of the intermediate assembly 200.

The instant invention is advantageously manufactured using known metal working and manufacturing techniques used to make pots and pans. However, the instant invention according hereto further include forming louvers 125 and standoff pillars 150 and circumferential dividers 127 or other emitters in the top wall 122 of base unit 100.

Examples. Throughout the following examples of use of the instant invention, an electric range provided the heat source, and the range “dial” was positioned to a “medium-high” position located between the numerals “6” and “7” on the “dial”. The base unit 100 and intermediate assembly 200 were heated on the stove for a period of 10 minutes before the food holder 300 containing the foodstuff was placed into/onto the instant invention.

### Example 1

### Melting 12 Ounces of Chocolate Chips

Food container placed into apparatus. No lid was used. Heat source set to medium.

| | Temperature of foodstuff | |
|---|---|---|
| Time (minutes) | (Fahrenheit) | Comments |
| 0 | 70 | Pre-heat pan |
| 10 | — | Add chocolate chips. |
| | | Stir when chips shiny on top. |
| | | Continue stirring until |
| | | chocolate is smooth. |
| 20 | — | Turn off heat source. Remove |
| | | pan from base. Spooned |
| | | chocolate from pan. Observed |
| | | no scorching or burning of the |
| | | chocolate. |

### Example 2

### Melting 8 Ounces of Separated Baking Chocolate Bars

Food container placed into apparatus. No lid was used. Heat source set to medium.

| | Temperature of foodstuff | |
|---|---|---|
| Time (minutes) | (Fahrenheit) | Comments |
| 0 | 70 | Pre-heat pan |
| 10 | — | Add baking chocolate |
| | | portions. |
| | | Stir when portions are about |
| | | half melted. |
| 17 | — | Stir when portions are about |
| | | half melted. |
| 20 | — | Chocolate melted. Stir until |
| | | smooth. Turn off heat source. |
| | | Remove pan from base. |
| | | Spooned chocolate from pan. |
| | | Observed no scorching or |
| | | burning of the chocolate. |

### Example 3

### Melting 14 Ounces of Caramels

Food container placed into apparatus. No lid was used. Heat source set to medium.

| | Temperature of foodstuff | |
|---|---|---|
| Time (minutes) | (Fahrenheit) | Comments |
| 0 | 70 | Pre-heat pan. Add caramels |
| | | and 2 Tbsp of water. |
| 10 | — | Melting - stir occasionally |
| | | until caramels are completely |
| | | melted. |
| 30 | — | Caramels completely melted. |
| | | Turn off heat source. Remove |
| | | pan from base. |

### Example 4

### Heat 2 Cups of Milk from Refrigerator

Food container placed into apparatus. No lid was used. No stirring. Heat source set to medium-high.

| | Temperature of foodstuff | |
|---|---|---|
| Time (minutes) | (Fahrenheit) | Comments |
| 0 | 40 | Add milk to pan. |
| 17 | 165 | Simmering. Turn off heat |
| | | source. Remove pan from |
| | | base. Observed that the milk |
| | | did not scorch or burn. |

### Example 5

### Cook 5.6 Ounce Package of Lipton® Rice—Chicken Flavor

Food container placed into apparatus. Heat source set to medium-high then reduced to medium-low.

| | Temperature of foodstuff | |
|---|---|---|
| Time (minutes) | (Fahrenheit) | Comments |
| 0 | 65 | No lid until after water boils. |
| 18 | — | Water boiling - stir rice into |
| | | water then cover. Reduce |
| | | heat to simmer (medium- |
| | | low). |
| 25 | — | Turn off heat source. Stir rice |
| | | then replace lid. Let stand for |
| | | 1-2 minutes. Stir and serve. |

### Example 6

### Cook 5.6 Ounce Package of Lipton® Pasta—Chicken Flavor

Food container placed into apparatus. No lid was used. Heat source set to medium-high.

| | Temperature of foodstuff | |
|---|---|---|
| Time (minutes) | (Fahrenheit) | Comments |
| 0 | 65 | — |
| 22 | — | Water boiling - add and stir |
| | | pasta. Continue boiling and |
| | | stir pasta occasionally until |
| | | pasta is tender. (7-8 min.). |
| 30 | — | Cook according to package |
| | | directions. |

### Example 7

### Cook 8 Ounces of Whole Kernel Corn from Frozen

Food container placed into apparatus. No lid was used. Heat source set to medium-high.

| | Temperature of foodstuff | |
|---|---|---|
| Time (minutes) | (Fahrenheit) | Comments |
| 0 | 10 | Add ¾ cup of water then |
| | | corn. |
| 15 | 125 | Stir occasionally. |
| 27 | 175 | Turn off heat source. |

### Example 8

### Cook 8 Ounces of Whole Kernel Corn from Refrigerated

Food container placed into apparatus. No lid was used. Heat source set to medium-high.

| | Temperature of foodstuff | |
|---|---|---|
| Time (minutes) | (Fahrenheit) | Comments |
| 0 | 40 | Add ¾ cup of water then |
| | | corn. |
| 15 | 175 | Stir occasionally. |
| 26 | 180 | Turn off heat source. |

### Example 9

### Cook 8 Ounces of Green Peas from Frozen

Food container placed into apparatus. No lid was used. Heat source set to medium-high.

| | Temperature of foodstuff | |
|---|---|---|
| Time (minutes) | (Fahrenheit) | Comments |
| 0 | 10 | Add ¾ cup of water then |
| | | peas. |
| 15 | 125 | Stir occasionally. |
| 26 | 175 | Turn off heat source. |

### Example 10

### Cook 8 Ounces of Mixed Vegetables from Frozen

Food container placed into apparatus. No lid was used. Heat source set to medium-high.

| | Temperature of foodstuff | |
|---|---|---|
| Time (minutes) | (Fahrenheit) | Comments |
| 0 | 10 | Add ¾ cup of water then |
| | | mixed vegetables. |
| 15 | 150 | Stir occasionally. |
| 26 | 180 | Turn off heat source. |

### Example 11

### Heat 10.5 Ounces of “Campbell's®” Old Fashioned Vegetable Soup

Food container placed into apparatus. No lid was used. Heat source set to medium-high.

| | Temperature of foodstuff | |
|---|---|---|
| Time (minutes) | (Fahrenheit) | Comments |
| 0 | 70 | Add soup and can of water. |
| | | Mix thoroughly. |
| 15 | — | Simmering. |
| 20 | 170 | Turn off heat source then stir. |

### Example 12

### Heat 10.75 Ounces of “Campbell's®” Tomato Soup

Food container placed into apparatus. No lid was used. Heat source set to medium-high.

| | Temperature of foodstuff | |
|---|---|---|
| Time (minutes) | (Fahrenheit) | Comments |
| 0 | 10 | Add soup and can of water. |
| | | Mix thoroughly. |
| 20 | 180 | Simmering. Turn off heat |
| | | source then stir. |

### Example 13

### Heat 15 Ounces of Mixed Vegetables from Room Temperature

Food container placed into apparatus. No lid was used. No stirring. Heat source set to medium-high.

| | Temperature of foodstuff | |
|---|---|---|
| Time (minutes) | (Fahrenheit) | Comments |
| 0 | 70 | Add vegetables. |
| 17 | 175 | Simmering. Turn off heat |
| | | source. |

### Example 14

### Heat 26.5 Ounces of Spaghetti Sauce from Room Temperature

Food container placed into apparatus. Lid was used. Heat source set to medium-high.

| | Temperature of foodstuff | |
|---|---|---|
| Time (minutes) | (Fahrenheit) | Comments |
| 0 | 70 | Add sauce. |
| 25 | 185 | Simmering. Turn off heat |
| | | source. |

### Example 15

### Heat 13 Ounces of Spaghetti Sauce from Refrigerator

Food container placed into apparatus. Lid was used. Heat source set to medium-high.

| | Temperature of foodstuff | |
|---|---|---|
| Time (minutes) | (Fahrenheit) | Comments |
| 0 | 40 | Add sauce. |
| 25 | 180 | Simmering. Turn off heat |
| | | source. |

### Example 16

### Heat 15 Ounces of Thick, Chunky Chili from Room Temperature

Food container placed into apparatus. No lid was used. Heat source set to medium-high.

| | Temperature of foodstuff | |
|---|---|---|
| Time (minutes) | (Fahrenheit) | Comments |
| 0 | 70 | Add chili. |
| 15 | 175 | Simmering. Turn off heat |
| | | source; remove from |
| | | apparatus. |

### Example 17

### Heat 15 Ounces of Beef Stew from Room Temperature

Food container placed into apparatus. No lid was used. Heat source set to medium-high.

| | Temperature of foodstuff | |
|---|---|---|
| Time (minutes) | (Fahrenheit) | Comments |
| 0 | 70 | Add stew. |
| 18 | 170 | Simmering. Turn off heat |
| | | source; remove from |
| | | apparatus. |

### Example 18

### Cook One Serving of Quaker Oats

Food container placed into apparatus. No lid was used. Heat source set to medium-high.

| | Temperature of foodstuff | |
|---|---|---|
| Time (minutes) | (Fahrenheit) | Comments |
| 0 | 70 | Add water. |
| 14 | — | Start boiling. Stir in oats. |
| | | Reduce heat to medium. Stir |
| | | occasionally until thickened. |
| 21 | — | Oats thickened. Turn off heat |
| | | source. |

### Example 19

### Cook Two Servings of Malt-O-Meal® w/ Maple and Brown Sugar

Food container placed into apparatus. No lid was used. Heat source set to medium-high.

| | Temperature of foodstuff | |
|---|---|---|
| Time (minutes) | (Fahrenheit) | Comments |
| 0 | 70 | Add water and meal. |
| 20 | — | Boiling. Stir constantly until |
| | | thickened. |
| 25 | — | Once thickened, turn off heat |
| | | source. Remove container |
| | | from apparatus. |

### Example 20

### Cook 5 Ounce Package of Jell-O—Cook & Serve® Banana Cream Pudding

Food container placed into apparatus. No lid was used. Heat source set to medium-high.

| | Temperature of foodstuff | |
|---|---|---|
| Time (minutes) | (Fahrenheit) | Comments |
| 0 | 40 | Add 3 cups of milk. |
| — | — | Add pudding mix and stir. |
| | | Bring mix to a boil. Stir often. |
| 25 | — | Turn off heat source. |
| | | Remove food container from |
| | | apparatus. |

### Example 21

### Cook 5 Ounce Package of Jell-O—Cook & Serve® Chocolate Pudding

Food container placed into apparatus. No lid was used. Heat source set to medium-high.

| | Temperature of foodstuff | |
|---|---|---|
| Time (minutes) | (Fahrenheit) | Comments |
| 0 | 40 | Add 3 cups of milk. |
| — | — | Add pudding mix and stir. |
| | | Bring mix to a boil. Stir often. |
| 22 | — | Turn off heat source. |
| | | Remove food container from |
| | | apparatus. |

### Example 22

### Steam Asparagus with One Cup of Water

Food container placed into apparatus. Lid was used. Heat source set to medium-high.

| | Temperature of foodstuff | |
|---|---|---|
| Time (minutes) | (Fahrenheit) | Comments |
| 0 | 60 | Use steamer tray. Add one |
| | | cup water. Place asparagus, |
| | | cut in half, on steamer tray |
| | | and cover. |
| 15 | — | Asparagus not too soft. Turn |
| | | off heat source. |

### Example 23

### Steam Brussel Sprouts with One Cup of Water

Food container placed into apparatus. Lid was used. Heat source set to medium-high.

| | Temperature of foodstuff | |
|---|---|---|
| Time (minutes) | (Fahrenheit) | Comments |
| 0 | 60 | Use steamer tray. Add one |
| | | cup water. Place peeled |
| | | sprouts on steamer tray and |
| | | cover. |
| 20 | — | Turn off heat source. |

### Example 24

### Steam Peeled and Quartered Large Carrots with One Cup of Water

Food container placed into apparatus. Lid was used. Heat source set to medium-high.

| | Temperature of foodstuff | |
|---|---|---|
| Time (minutes) | (Fahrenheit) | Comments |
| 0 | 65 | Add water. Place carrots on |
| | | steam tray and cover. |
| 25 | — | Firm carrots. Turn off heat |
| | | source. |

### Example 25

### Steam Quartered Head of Cabbage with One Cup of Water

Food container placed into apparatus. Lid was used. Heat source set to medium-high.

| | Temperature of foodstuff | |
|---|---|---|
| Time (minutes) | (Fahrenheit) | Comments |
| 0 | 65 | Add water. Unscrew lift rod |
| | | from steamer tray, place a |
| | | cut side of cabbage on |
| | | steam tray, then cover. |
| 25 | — | Turn off heat source. |

### Example 26

### Steam Whole Small White Potatoes, Skin on, with One Cup of Water

Food container placed into apparatus. Lid was used. Heat source set to medium-high.

| | Temperature of foodstuff | |
|---|---|---|
| Time (minutes) | (Fahrenheit) | Comments |
| 0 | 60 | Add water. Place scrubbed |
| | | and eyed potatoes on steam |
| | | tray, then cover. |
| 40 | — | Fork test, potatoes are |
| | | cooked. Turn off heat |
| | | source. |

### Example 27

### Steam Whole Small Red Potatoes, Skin on, with One Cup of Water

Food container placed into apparatus. Lid was used. Heat source set to medium-high.

| | Temperature of foodstuff | |
|---|---|---|
| Time (minutes) | (Fahrenheit) | Comments |
| 0 | 65 | Add water. Placed scrubbed |
| | | and eyed potatoes on steam |
| | | tray, then cover. |
| 40 | — | Fork test, potatoes are |
| | | cooked. Turn off heat |
| | | source. |

### Example 28

### Steam Two Servings of Broccoli from the Refrigerator

Food container placed into apparatus. Lid was used. Heat source set to medium-high.

| Time (minutes) | Temperature of foodstuff | Comments |
|---|---|---|
| 0 | 40 | Add water. Place broccoli on |
| | | steam tray, then cover. |
| 15 | — | Turn off heat source. |

### Example 29

### Steam Mini Corn on the Cob from Freezer

Food container placed into apparatus. Lid was used. Heat source set to medium-high.

| | Temperature of foodstuff | |
|---|---|---|
| Time (minutes) | (Fahrenheit) | Comments |
| 0 | 10 | Add water. Place corn, on its |
| | | side or on an end, upon |
| | | steam tray, then cover. |
| 30 | — | Corn heated through. Turn |
| | | off heat source. |

The above description has set out various features, functions, methods and other aspects of the inventions. This has been done with regard to the currently preferred embodiments hereof. Time and further development may change the manner in which the various aspects are implemented. Such aspects may further be added to by the language of the claims which are incorporated by reference hereinto as originally filed.

The scope of protection accorded the inventions as defined by the claims is not intended to be necessarily limited to the specific sizes, shapes, features or other aspects of the currently preferred embodiments shown and described. The claimed inventions may be implemented or embodied in other forms while still being within the concepts shown, described and claimed herein. Also included are equivalents of the inventions which can be made without departing from the scope of concepts properly protected hereby.

Having thusly described my invention, the preferred embodiment and its use, I pray issuance of UTILITY LETTERS PATENT.

I claim:

1. An apparatus for heating fluidic and semi-fluidic foodstuffs in a fluid impermeable food holder using a heat source, the apparatus comprising:
a base unit having a sidewall and a top wall and defining an open bottom chamber, the base unit adapted for placement over and about the heat source to capture heat from the heat source in the open bottom chamber;
a plurality of spacedly arrayed louvers defined in the top wall of the base unit, each of the plurality of spacedly arrayed louvers communicating with the open bottom chamber to allow heated air from the open bottom chamber to pass through each of the plurality of spacedly arrayed louvers;
an intermediate assembly having a substantially annular configuration with an open top medial portion carried on a top portion of the base unit to contain and direct flow of heated air passing through each of the plurality of spacedly arrayed louvers around and about a bottom and side portions of the fluid impermeable food holder when the fluid impermeable food holder is positioned within the intermediate assembly; and
at least one positioner communicating with the base unit and the intermediate assembly for positioning the fluid impermeable food holder in a desired position relative to the base unit and of the intermediate assembly.

2. The apparatus of claim 1 wherein:
the food holder is adapted to fit into the top opening defined by the intermediate assembly.

3. The apparatus of claim 1 wherein:
the plurality of spacedly arrayed louvers are structurally configured to emit heated air from the open bottom chamber in a direction which includes at least some lateral movement and at least some vertical movement.

4. The apparatus of claim 1 wherein:
the plurality of spacedly arrayed louvers defined in the base unit top wall are each configured to emit heated air from the open bottom chamber in a direction which includes at least some component of lateral movement and at least some component of vertical movement, and the lateral direction is perpendicular to a radius of the base unit top wall.

5. The apparatus of claim 1 wherein:
the at least one positioner extends radially inwardly from the base unit sidewall to laterally position the food holder in a top opening defined by the intermediate assembly.

6. The apparatus of claim 1 wherein:
the intermediate assembly joins with the base unit using an engaging joint which resists displacement of the intermediate assembly relative to the base unit.

7. The apparatus of claim 1 wherein:
the at least one positioner includes a portion which positionally maintains the intermediate assembly relative to the base unit.

8. The apparatus of claim 1 wherein:
the plurality of spacedly arrayed louvers are arranged in a pattern of plural spaced concentric rings, the plural concentric rings separated from each other by a concentric divider, and the plurality of spacedly arrayed louvers each emit heated air therethrough in a direction perpendicular to a radial line extending from a center of the base unit.

9. The apparatus of claim 1 further comprising:
a handle communicating with the base unit.

10. The apparatus of claim 1 further comprising:
plural spacedly arrayed standoff pillars extending vertically upwardly from the base unit top wall, opposite to the open bottom chamber, for spacing the fluid impermeable food holder above the plurality of spacedly arrayed louvers to allow heated air to circulate around and about the fluid impermeable food holder and to minimize conductive heating of the food holder.

11. An apparatus for heating fluidic and semi-fluidic foodstuffs in a fluid impermeable food holder using a heat source, the apparatus comprising:
a base unit which is adapted for placement over and about the heat source to collect heat generated by the heat source within an open bottom chamber formed at least in part when the base unit is installed over and about the heat source;
an annular shaped intermediate assembly which detachably joins with the base unit and forms a receiver for the fluid impermeable food holder and which positions the fluid impermeable food holder so that the fluid impermeable food holder receives even heating from heated air within the open bottom chamber; and
plural spacedly arrayed louvers defined in a top wall of the base unit which discharge heated air from the open bottom chamber into intermediate assembly in a direction so that the heated air moves about the fluid impermeable food holder placed within the intermediate assembly to provide even heating to the fluid impermeable food holder.
